(19) United States
(12) Patent Application Publication
(10) Pub. No.: US 2020/0063485 A1
(43) Pub. Date: Feb. 27, 2020

(54) Energy Saving Aluminum Alloy Horizontal Slide Window with Maximized Manufacture Material Saving

(71) Applicant: Leo I Lun Lan, St. Albana, NY (US)

(72) Inventor: Leo I Lun Lan, St. Albana, NY (US)

(21) Appl. No.: 16/112,690

(22) Filed: Aug. 25, 2018

(51) Int. Cl. E06B 3/46; E06B 3/08

(52) U.S. Cl. CPC E06B 3/4609; E06B 3/08

(57) ABSTRACT

The invention describes the new aluminum alloy window design to provide increased energy saving, water proof, wind proof and how to maximize the material during the manufacturing process. There are only six different aluminum alloy extrusion pieces to construct the main structure of this aluminum sliding window. The current aluminum sliding window sold in USA usually consist of at least eight main aluminum alloy extrusion pieces. With this new window design, the window manufacture will be able to save on labor, material and inventory throughout the manufacturing process. Please see FIG. 1 for detail.

The exterior frame and plain stile of the aluminum sliding window have three stopping points consisting with one special designed shark-gill shape rubber strip and two brush seals. See FIGS. 2 and 3 for detail cross section diagram of the aluminum sliding window exterior frame and plain stile. With this window design, the outside cold air will need to make six turns in order to flow into inside of house. The head and sill of the exterior window frame have thermal insulation dividers to provide waterproof, windproof and thermal insulation function of the main window section. Please see FIG. 4 for illustration of this function. The meeting stile of the interior window has interlock mechanism with double shark-gill shape rubber strips to provide vertical water/wind proof in addition to the thermal insulation function. See FIG. 5 for detail on the window meeting stile cross section diagram. With this new window design, the window will reduce the manufacture cost and provide better and energy efficient window to customers.

### TECHNOLOGY FIELD

The present invention belongs to an improvement on the existing aluminum alloy horizontal sliding double pane glass window with the following features: improved thermal insulation, improved wind proof, enhance water blocking and maximized the manufacture materials with only six different aluminum extrusion parts in construction of the sliding window. See FIG. 1 for description on the six different types of windows main part.

### BACKGROUND TECHNIQUE

The current aluminum horizontal sliding window in the market has lower performance in thermal, water and wind insulation. With the improve structure design in aluminum extrusion parts with enhanced insulation construction in the middle, the window provides a better thermal insulation. Other enhancements in this new window design around the edge of the window provides additional water blocking and wind proof features. The current aluminum window manufacturing process contains at least 8 aluminum extrusion pieces which is less efficient and taking longer time to complete the window construction. The overall cost to produce this horizontal sliding window will be reduced with this new six-pieces window construction design.

### INVENTION

This invention enhanced the current sliding window design and overcome the common issues and technical defects based on the feedback from customers. The purpose of this new window design is to save the cost of material to construct the window and enhance the thermal insulation to create a more energy saving window. Eventually, create a more economic and energy efficient aluminum alloy horizontal sliding double pane glass window.

### BRIEF DESCRIPTION OF THE DRAWINGS

The above and related objects, feature and advantages of the presented invention will be fully understood by the reference of detail description of each drawing.

FIG. 1. explains that only six different type of aluminum construction pieces:

1. Head

2. Jamb

3. Sill

4. Top/bottom rail

5. Plain stile

6. Meeting stile

comparing to the traditional aluminum window assembly with at least eight different type of construction pieces.

FIG. 2. describes the horizontal cross section view of plain stile and jamb. The top and bottom brush seals provide wind, water and sound proof benefits. While the rubber strip offers water proof and thermal insulation advantages.

FIG. 3. illustrates this new windows design creating six 90 degrees corners with wind proof material to stop wind roving from outside to inside of the building.

FIG. 3.1. demonstrates the common aluminum window design with only two 90 degrees corner without any wind proof material to stop wind traveling into indoor of the building.

FIG. 4. illustrates the vertical cross section view where the head and top rail meets. The arrow points to where the wind proof and water barrier features. The location where bottom rail and sill meets provides the wind proof and water barricade using the plastic brush seal.

FIG. 5. shows the horizontal cross section view of the two meeting stiles. When the two window pieces close together, the window will automatically lock with the interlock mechanism. Again, the shark gill shape rubber strips provide wind, water and sound proof benefits. The track direction indicates the direction on how to close the two pieces of window panel.

FIG. 6. demonstrates the feature to adjust the height of the inner window piece with the adjustment rod.

FIG. 7. illustrates the thermal breaker line which provides the thermal insulation feature from the vertical and horizontal cross section view of the aluminum window.

What is claimed is:

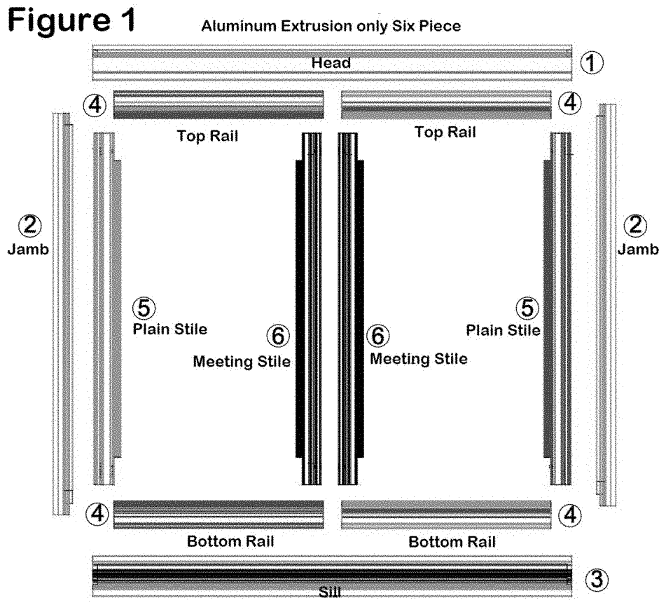

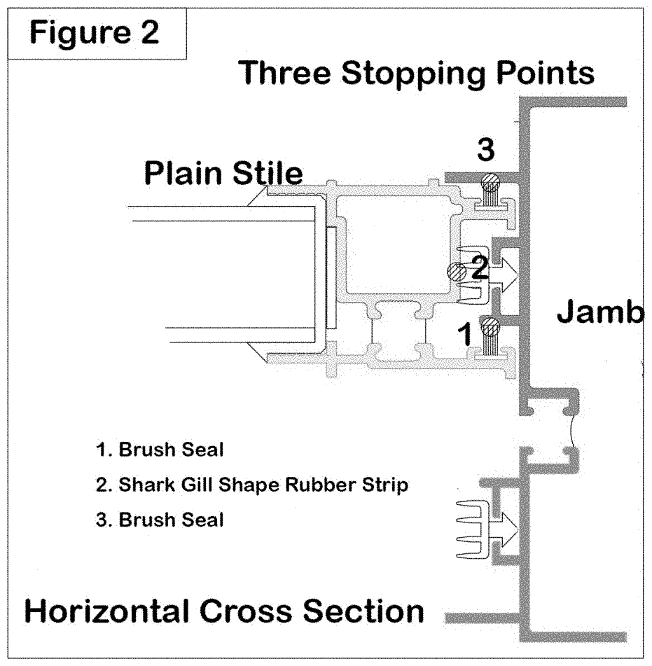

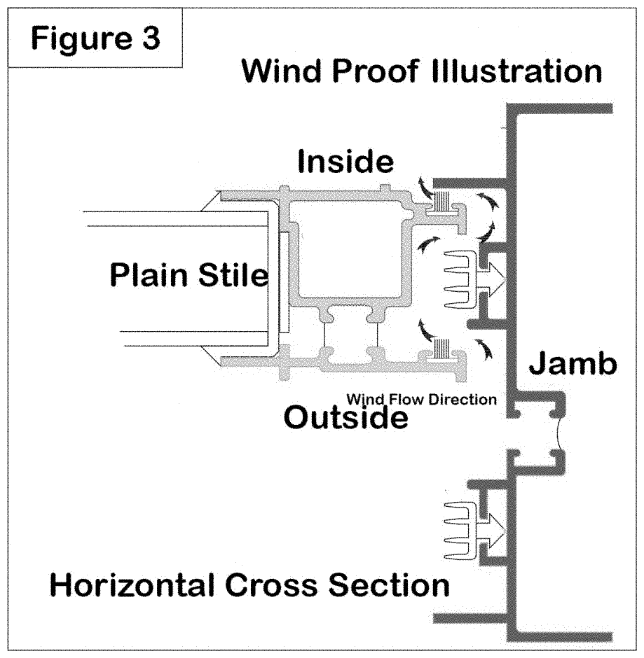

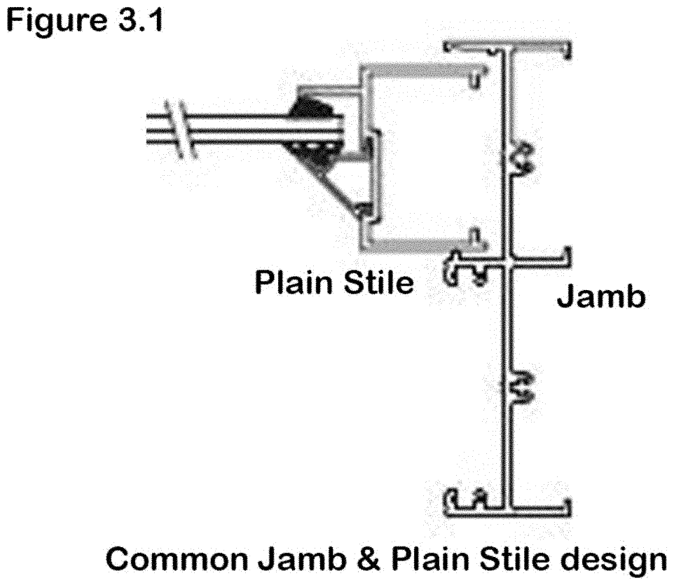

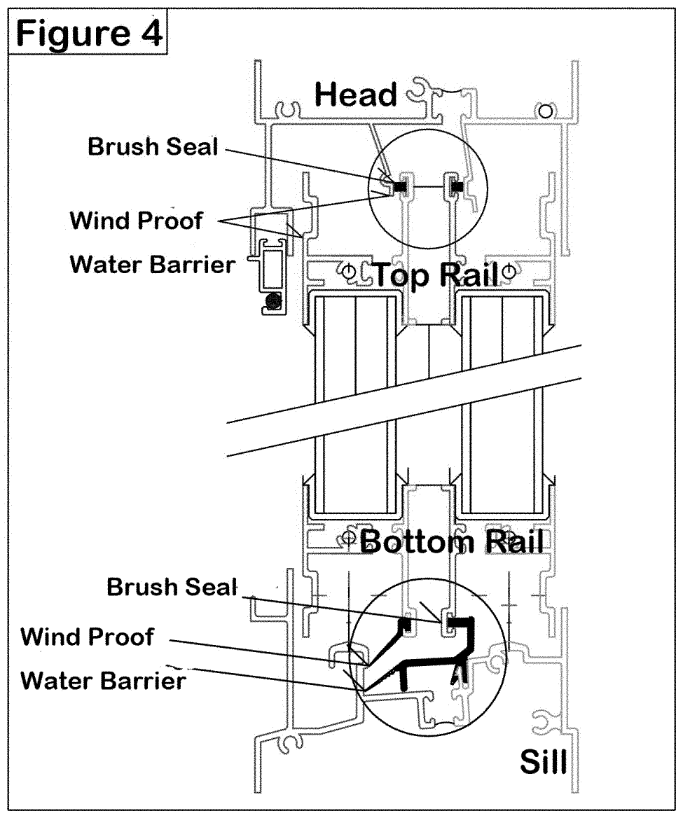

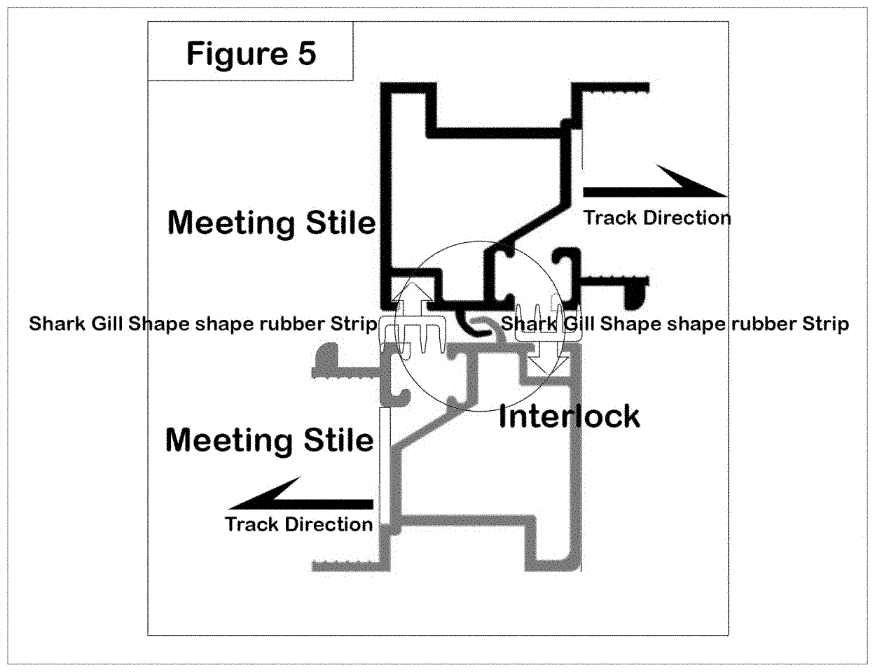

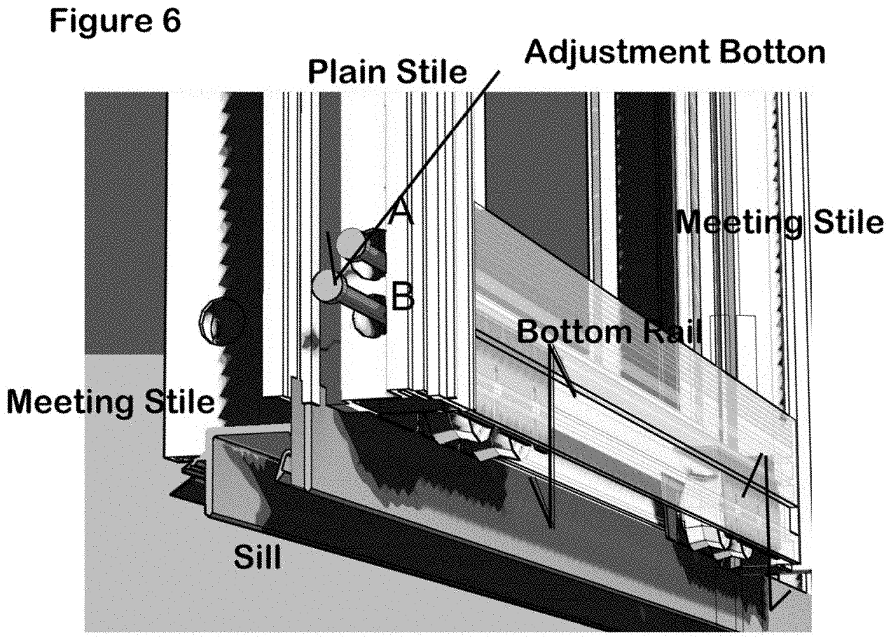

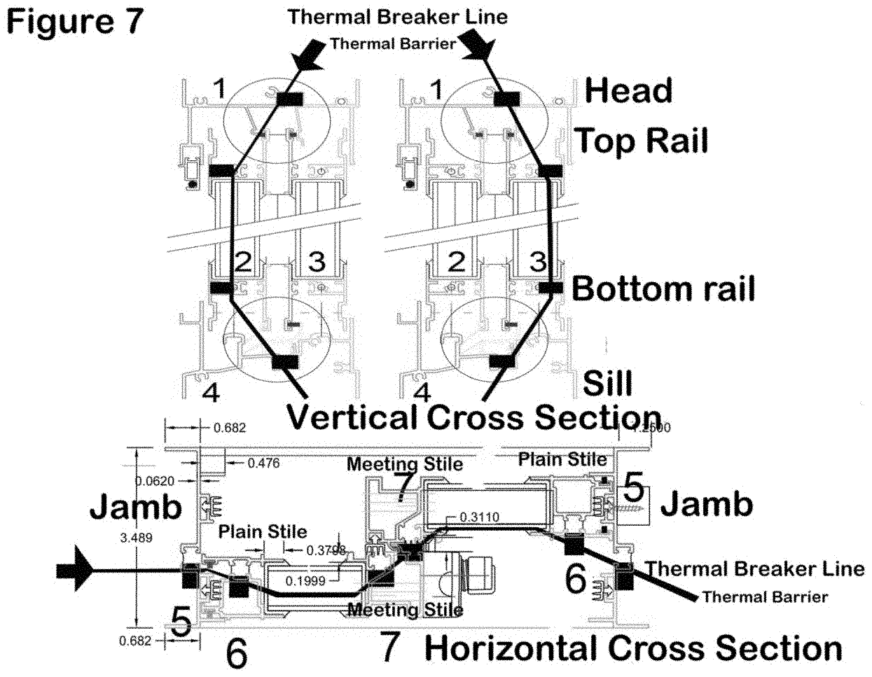

1. A double glass aluminum alloy horizontal sliding window consists of the following features
1. The meeting stile of the window contains one special designed shark-gill shape rubber. Please see FIG. 1. for each of the window major component. Please see FIG. 5 for the feature described here.
2. The plain stile of the window contains two brush seals. Please see FIG. 3 for the feature described here.
3. The top and bottom rail the window contains one brush seal. Please see FIG. 4 for the feature described here.
4. The bottom rail of the window contains two height adjustable double wheels trolleys. Please see FIG. 6 for the feature described here.
5. The head of the window contains two tiled tracks to hold the two plain stiles in place. Please see FIG. 4 for the feature described in this section.
a. The tiled track design provides easy access to take the plain stile in or out of the window frame.
b. The track also stops the wind draft and prevents water from coming inside the window. FIG. 4 displays this feature.
6. The sill of the window contains the rectangular sharp plastic thermal insulator. The sill also provides features to stop the wind draft and prevent water from coming inside the window due to the height of the insulator. Please see FIG. 4 for the feature described here.
7. The exterior frame and plain stile of the aluminum sliding window have three stopping points consisting with one special designed shark-gill shape rubber strip and two brush seals. See FIG. 2 for detail cross section diagram of the aluminum sliding window exterior frame and plain stile. FIG. 3 illustrates wind proof design feature; the outside cold air will need to make six turns to flow into inside of house. Thus, this energy efficient window creates a better thermal insulation compare to the common horizontal sliding aluminum alloy window design.
8. This new window design only uses six different aluminum alloy extrusion pieces to construct the main structure of this aluminum sliding window. The current aluminum sliding window sold in United States of America usually consists of at least eight main aluminum alloy extrusion pieces. With this new window design, the window manufacture will be able to save on labor, material, and inventory throughout the manufacturing process. Please see FIG. 1 for feature described here.
9. The middle of all six different pieces of aluminum alloy extrusion pieces of the window contain thermal insulation to provide better energy efficiency for year-round weather. Please see FIG. 7 for feature described here.
